(19) United States
(12) Patent Application Publication
(10) Pub. No.: US 2023/0241910 A1
(43) Pub. Date: Aug. 3, 2023

(54) HANDLE ASSEMBLY FOR A FLUID CONTAINER

(71) Applicant: IMAGINE THE SOLUTION, LLC, Detroit, MI (US)

(72) Inventor: Rene Torres, Saginaw, MI (US)

(73) Assignee: IMAGINE THE SOLUTION, LLC, Detroit, MI (US)

(21) Appl. No.: 18/104,958

(22) Filed: Feb. 2, 2023

Related U.S. Application Data
(60) Provisional application No. 63/306,018, filed on Feb. 2, 2022.

(51) Int. Cl. B44D 3/00; B65D 25/28

(52) U.S. Cl. CPC B44D 3/00; B65D 25/28; B65D 2525/285; F16B 2001/0035

(57) ABSTRACT

Embodiments herein are directed to a handle assembly for releasable coupling to an exterior surface of a tray that is configured to retain a fluid is provided. The handle assembly includes a base member and a quick-release attachment assembly. The base member includes an elongated member that has a distal end, an opposite proximal end and a planar portion having an outer surface. The planar portion is positioned to extend from the proximal end and above the proximal end of the elongated member in a vertical direction. The quick-release attachment assembly has an interior surface and an opposite exterior surface. The interior surface is coupled to and extending from the outer surface of the planar portion of the elongated member. The exterior surface of the quick-release attachment assembly is adapted to releasable couple the elongated member to the exterior surface of the tray.

### CROSS REFERENCE FOR RELATED APPLICATIONS

The present application claims priority to U.S. Provisional patent application Ser. No. 63/306,018 filed on Feb. 2, 2022, and entitled “Easy Grip”, the contents of which are incorporated herein in its entirety.

### TECHNICAL FIELD

The present specification generally relates to handles for fluid containers and, more specifically, to handles that are removably coupled to fluid containers.

### BACKGROUND

Fluid containers, such as a paint tray that hold or contains paint, are generally held from an edge or from a lip of the paint tray with one hand while the painter uses their other hand to apply the paint. As such, the painter may be focused on painting, which may cause the painter to lower or tip the paint try causing the paint contained within the paint tray to spill. Further, the hand or arm of the painter that is grasping or clinching to hold the paint tray from the edge and/or the lip, may become fatigued to cause the painter to lower or tip the paint try, which in turn causes the paint contained within the paint tray to spill. Further, continuous holding or grasping of the edge or lip of the paint try may result in long lasting cramps/pain of the hand of the painter.

### SUMMARY

In one embodiment, a handle assembly for releasable coupling to an exterior surface of a tray that is configured to retain a fluid is provided. The handle assembly includes a base member and a quick-release attachment assembly. The base member includes an elongated member that has a distal end, an opposite proximal end and a planar portion having an outer surface. The planar portion is positioned to extend from the proximal end and above the proximal end of the elongated member in a vertical direction. The quick-release attachment assembly has an interior surface and an opposite exterior surface. The interior surface is coupled to and extending from the outer surface of the planar portion of the elongated member. The exterior surface of the quick-release attachment assembly is adapted to releasable couple the elongated member to the exterior surface of the tray.

In another embodiment, a handle assembly for releasable coupling to an exterior surface of a paint tray is provided. The handle assembly includes an elongated member and a magnetic sheet. The elongated member has a distal end, an opposite a proximal end, and a planar portion having an outer surface. The planar portion positioned to extend from the proximal end and above the proximal end of the elongated member in a vertical direction. The magnetic sheet is coupled to the outer surface of the planar portion and adapted to releasable couple the elongated member to the exterior surface of the paint tray when the exterior surface is magnetic.

In yet another embodiment, a handle assembly for releasable coupling to an exterior surface of a paint tray, the exterior surface of the paint tray having a plurality of corresponding receiving hook and loop fasteners positioned thereon is provided. The handle assembly includes an elongated member and a plurality of hook and loop fasteners. The elongated member has a distal end, an opposite proximal end, and a planar portion having an outer surface. The planar portion is positioned to extend from the proximal end and above the proximal end of the elongated member in a vertical direction. The plurality of hook and loop fasteners are coupled to the outer surface of the planar portion. The plurality of hook and loop fasteners are configured to releasable couple the elongated member to the exterior surface of the paint tray when mated with the plurality of corresponding receiving hook and loop fasteners positioned on the exterior surface of the paint tray.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a side perspective view of a first aspect example handle assembly releasably coupled to an exterior surface of an example tray according to one or more embodiments shown and described herein;

FIG. 2 schematically depicts a bottom perspective view of the example handle assembly releasably coupled to the exterior surface of the example tray of FIG. 1 according to one or more embodiments shown and described herein;

FIG. 3 schematically depicts a perspective view of the first aspect of the example handle assembly separated from the exterior surface of the example tray of FIG. 1 and illustrating the example handle assembly with a magnetic sheet according to one or more embodiments shown and described herein;

FIG. 4 schematically depicts an exploded view of the example handle assembly of FIG. 3 according to one or more embodiments shown and described herein;

FIG. 5A schematically depicts a top perspective view of the example handle assembly releasably separated from the exterior surface of the tray of FIG. 1 illustrating the example handle assembly with a plurality of hook and loop fasteners according to one or more embodiments shown and described herein;

FIG. 5B schematically depicts a top perspective view of the example handle assembly releasably separated from the exterior surface of the tray of FIG. 1 illustrating the example handle assembly with a hook and loop fastener sheet according to one or more embodiments shown and described herein

FIG. 6 schematically depicts a bottom perspective view of a second example handle assembly releasably coupled to the exterior surface of an example tray according to one or more embodiments shown and described herein;

FIG. 7 schematically depicts a top perspective view of the second example handle assembly releasably separated from the exterior surface of the tray of FIG. 6 illustrating the second example handle assembly with a plurality of magnetic strips according to one or more embodiments shown and described herein;

FIG. 8 schematically depicts an exploded view of the second example handle assembly of FIG. 7 according to one or more embodiments shown and described herein;

FIG. 9 schematically depicts a side view of the second example handle assembly of FIG. 7 according to one or more embodiments shown and described herein;

FIG. 10 schematically depicts a bottom perspective view of the second example handle assembly releasably separated from the exterior surface of the second example tray of FIG. 6 illustrating the second example handle assembly with a plurality of hook and loop fasteners according to one or more embodiments shown and described herein; and

FIG. 11 schematically depicts a side view of the second example handle assembly of FIG. 10 according to one or more embodiments shown and described herein.

### DETAILED DESCRIPTION

Embodiments herein are directed to a handle assembly for releasable coupling to an exterior surface of a fluid container, such as a tray that is configured to retain a fluid, such as paint. The handle assembly includes an elongated member that has a distal end an opposite proximal end and a planar portion. A length of the elongated member extending in a vertical direction is conducive to allow a user to grip or wrap fingers around the elongated member between the distal end and the proximal end.

The planar portion includes an outer surface and is formed integrally with the elongated member. The planar portion is configured to receive various tray connectors of a quick-release attachment assembly to releasable couple the elongated member to the exterior surface of the tray. Example tray connectors of the quick-release attachment assembly include magnets, hook and loop fasteners, and the like, positioned on or coupled to the outer surface of the planar portion. The planar portion may generally be a rectangular shape with four different edge portions. Each of the four edges are positioned beyond the outer diameter of the proximal end and distal end of the elongated member. A center of the planar portion is coaxially aligned with the center axis of the elongated member.

In some embodiments, the quick-release attachment assembly includes a magnetic sheet coupled to the outer surface of the planar portion and is configured to releasable couple the elongated member to the exterior surface of the tray when the exterior surface is magnetic. In other embodiments, the outer surface of the planar portion includes a plurality of magnetic strips coupled thereto. The plurality of magnetic strips are configured to releasable couple the elongated member to the exterior surface of the tray when the exterior surface is magnetic. In other embodiments, the outer surface of the flange portion includes a hook and loop fastener that is coupled to the outer surface of the planar member and a corresponding receiving hook and loop fastener that is positioned on the exterior surface of the paint tray. The hook and loop fastener is configured to releasable couple the elongated member to the exterior surface of the paint tray when mated with the corresponding receiving hook and loop fastener positioned on the exterior surface of the tray. In other embodiments, the outer surface of the planar portion includes a plurality of spaced apart hook and loop fasteners coupled thereto and a plurality of corresponding spaced apart receiving hook and loop fasteners positioned on the exterior surface of the tray. The plurality of hook and loop fasteners are configured to releasable couple the elongated member to the exterior surface of the tray when mated with the plurality of corresponding receiving hook and loop fasteners positioned on the exterior surface of the tray.

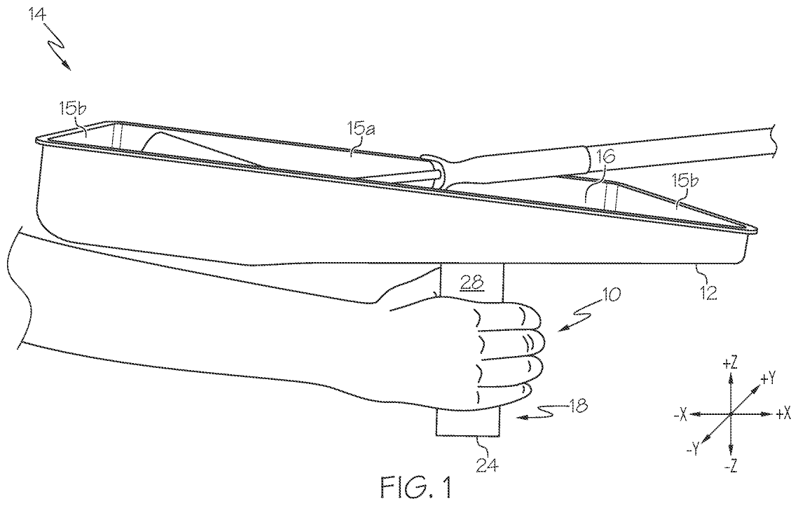

As used herein, the term “longitudinal direction” refers to the forward-rearward direction of the assembly (i.e., in a +/−X direction of the coordinate axes depicted in FIG. 1). The term “lateral direction” refers to the cross-direction of the assembly (i.e., along the Y axis of the coordinate axes depicted in FIG. 1), and is transverse to the longitudinal direction. The term “vertical direction” refers to the upward-downward direction of the assembly (i.e., in the +/−Z direction of the coordinate axes depicted in FIG. 1). As used herein, “upper” or “uppermost” is defined as generally being towards the positive Z direction of the coordinate axes shown in the drawings. “Lower” or “lowermost” is defined as generally being towards the negative Z direction of the coordinate axes shown in the drawings.

Referring initially to FIGS. 1-4, a handle assembly 10 is schematically depicted. The handle assembly 10 may be configured to releasably couple the handle assembly 10 to an exterior surface 12 of a tray 14. The tray 14 includes a pair of sidewalls 15a and a pair of end walls 15b that surround a recessed portion 16 that is configured to retain a fluid, such as paint between the pair of sidewalls 15a, the pair of end walls 15b and the exterior surface 12. In this illustrated embodiment, the handle assembly 10 includes a base member 17 and a quick-release attachment assembly 22. The base member 17 includes an elongated member 18. The elongated member 18 includes a distal end 24, a proximal end 26 that is spaced apart and opposite of the distal end 24, and a planar portion 34. In some embodiments, the distance or length L1 between the proximal end 26 and the distal end 24 is long enough to allow a user to grip the elongated member 18. For example, the length L1 may be 4 inches. It should be understood that the length L1 may be longer than 4 inches or shorter than 4 inches. In some embodiments, the elongated member 18 has an outer surface 28 that may have indentions 27 or grooves to assist the user with gripping the elongated member 18. In other embodiments, the outer surface 28 of the elongated member 18 may be textured or otherwise manipulated to assist the user with grip of the elongated member 18. Further, in some embodiments, without limitation, the elongated member 18 or handle may have a diameter D2 of 2 inches. In other embodiments, the diameter D2 of the elongated member 18 may be more than or less than 2 inches.

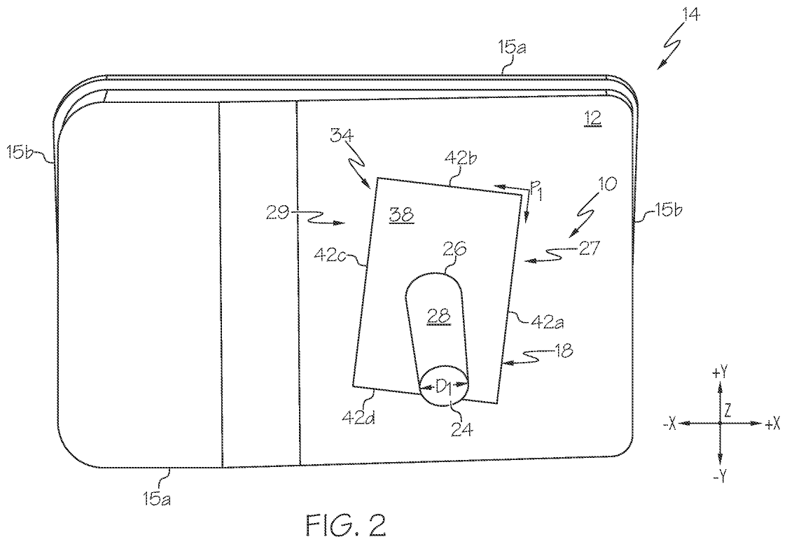

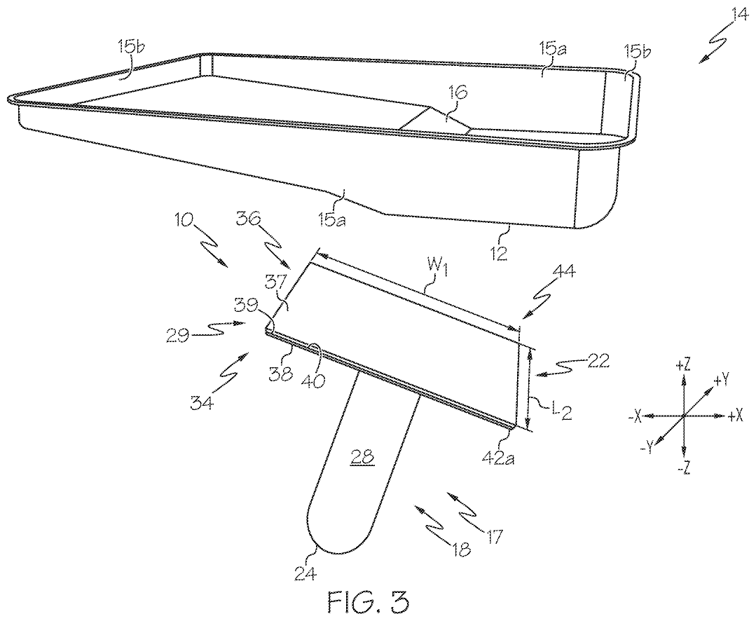

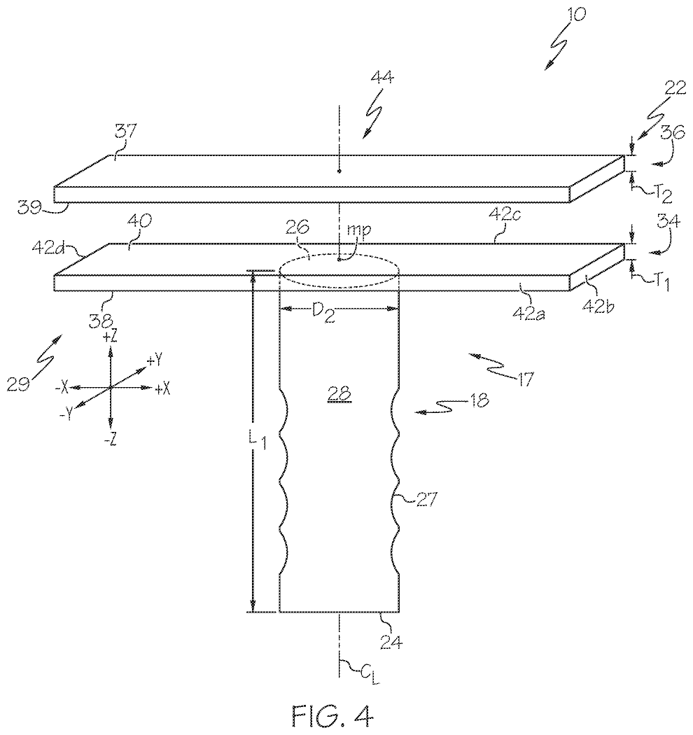

Now referring to FIG. 3, in some embodiments, the distal end 24 may be tapered or rounded. As such, a diameter D1 of the distal end 24 may be less than a diameter D2 of the proximal end 26. In a non-limiting example, the diameter D2 of the proximal end 26 may be 2 inches and the diameter D1 of the distal end may be less than 2 inches. As such, the proximal end 26 may have a larger or more surface area compared to the distal end 24. This is non-limiting, and, in other depicted embodiments, such as in FIGS. 2 and 4, the distal end 24 may have the same or equal diameter to the proximal end 26. In other embodiments, the distal end 24 may have a larger diameter than the proximal end 26.

Referring back to FIGS. 1-4, a centerline C1 is schematically depicted extending along an axis in the vertical direction (i.e., in the +/−Z direction). An upper portion 29 of the base member 17 includes the planar portion 34 extending from the elongated member 18 and the tray attachment portion 36 may be coupled thereon, as discussed in greater detail herein. The planar portion 34 has an inner surface 38 and an opposite outer surface 40 that is spaced apart from the inner surface 38 to define a thickness T1 of the planar portion 34. In a non-limiting example, the thickness T1 of the planar portion 34 is ⅛ inch. That is, the thickness between the inner surface 38 and the outer surface 40 is ⅛ inch. It should be understood that this is non-limiting and the thickness T1 of the planar portion 34 may be more than or less than ⅛ inches. It should be understood that the thickness T1 provides for a stable attachment or coupling surface for the tray attachment portion 36, as discussed in greater detail herein. It should also be appreciated that while the planar portion 34 is depicted as having a uniform thickness, this is for illustrative purposes and the thickness T1 of the planar portion 34 may vary.

In the illustrated embodiment, the planar portion 34 is formed integrally with the elongated member 18 to be a single monolithic structure. That is, each may be molded or manufacturing together to form a single piece such as using injection molding techniques, three-dimensional printing techniques, and the like. That is, the planar portion 34 extends from the proximal end 26 of the elongated member 18 as a single piece.

In the illustrated embodiment, the planar portion 34 is formed integrally with the elongated member 18 to generally form a “T” shape. This is non-limiting and many other shapes are envisioned such as a “C” shape, “L” shape, and the like. As such, in some embodiments, the planar portion 34 may generally be a rectangular shape with four edges 42a, 42b, 42c, 42d positioned radially outward from a mid-point MP centrally positioned between the four edges 42a, 42b, 42c, 42d. The mid-point MP may be coaxially aligned with the central line CL of the elongated member 18 such that the planar portion 34 is coaxially aligned with the elongated member 18.

In some embodiments, the planar portion 34 includes the pair of sides or edges 42a, 42c, that are equal and the pair of sides or edges 42b, 42d that are equal and extend less than the pair of sides or edges 42a, 42c. In a non-limiting example, the pair of sides or edges 42a, 42c may be illustratively orientated, as depicted in FIG. 3, to extend in the longitudinal direction (i.e., in the +/−X direction) such that the pair of sides or edges 42a, 42c have a length of 5 inches illustrated by arrow W1. In a non-limiting example, the pair of sides or edges 42b, 42d may be illustratively orientated, as depicted in FIG. 3, to extend in the lateral direction (i.e., in the +/−Y direction) such that the pair of sides or edges 42b, 42d have a length of 3.5 inches illustrated by arrow L2. As such, in this non-limiting example, the pair of sides or edges 42b, 42d have a length less than the pair of sides or edges 42a, 42c forming a rectangular shape. It should be understood that the generally rectangular shape depicted is non-limiting and the planar portion 34 may be any other shape including circular, square, hexagonal, octagonal, and the like.

Each of the four edges 42a, 42b, 42c, 42d form a perimeter P1 that is positioned or terminates beyond the outer diameter D2 and D1 of the distal end 24 and proximal end 26 of the elongated member 18. As such, the perimeter P1 of the planar portion 34 extends beyond the elongated member 18 and may have a greater area than the elongated member 18. For example, using the example above, the perimeter P1 of the planar portion 34 may be 17 inches (e.g., the edges 42b, 42d each has a length of 3.5 inches illustrated by arrow L2 and the edges 42a, 42c each has a length of 5 inches illustrated by arrow W1 in FIG. 3). As discussed above, it should be understood that this is non-limiting and each length and/or width of the sides may vary thus changing the perimeter of the planar portion 34 to be more than or less than 17 inches. As such, it should be understood that the surface area of the planar portion 34 may be sized and shaped to provide a stable platform for the tray attachment portion 36 to couple to the outer surface 40 of the planar portion 34.

Referring still to FIGS. 1-4, the elongated member 18 including the planar portion 34 may be formed from a wood material, a plastic material, a composite material, a metal material, and/or the like. For example, various woods may include, without limitation, oak, pine, hickory, and/or the like. Various plastics may include, without limitation, polyethylene (PE), polypropylene (PP), polyethylene terephthalate (PET), polyvinyl chloride (PVC) and polystyrene (PS), and the like, and some thermosetting plastics may include polyurethane (PUR) and epoxy resins or coatings, and the like. Various composite materials may include, without limitation, reinforced plastics, such as fibre-reinforced polymer or fiberglass, and the like. Various metals may include, without limitation, copper, aluminum, steel, iron, alloys, and the like.

Referring now to FIGS. 3-4, the tray attachment portion 36 may be coupled to the outer surface 40 of the planar portion 34. The tray attachment portion 36 may include an exterior surface 37 and an opposite interior surface 39 defining a thickness T2. As such, the interior surface 39 may be coupled or attached to the outer surface 40 of the planar portion 34. In some embodiments, the tray attachment portion 36 may have a thickness T2 of ⅛ inch. It should be understood that this is non-limiting and the thickness T2 of the tray attachment portion 36 may be more than or less than ⅛ inch. It should be understood that the thickness T2 provides for a stable attachment or coupling surface for attaching or coupling the tray 14 to the elongated member 18, as discussed in greater detail herein.

In one embodiment, the tray attachment portion 36 may be a magnetic sheet 44 coupled to the outer surface 40 of the planar portion 34. In other embodiments, the tray attachment portion 36 may be a plurality of magnetic strips coupled to the outer surface 40 of the planar portion 34. The magnetic sheet 44 may be coupled to substantially cover the outer surface 40 of the planar portion 34. In some embodiments, the magnetic sheet 44 may be coupled to the outer surface 40 of the planar portion 34 via a fastener. Example fasteners include a screw, a rivet, a bolt and nut, epoxy, adhesive, hook and loop, weld, and/or the like.

The magnetic sheet 44 is configured to releasable couple the elongated member 18 to the exterior surface 12 of the tray 14 in case where the tray 14 is made of, or from, or has, a magnetic material. For example, the tray 14 may be made from a metal material that is magnetic. As such, the magnetic sheet 44 releasably couples to the exterior surface 12 such that the elongated member 18 extends in the vertical direction (i.e., in the +/−Z direction) below the exterior surface 12 of the tray in a downward direction. Such an arrangement allows for the user to hold onto the elongated member 18, and in some embodiments, balance the remaining portion of the exterior surface 12 on a forearm of the user or positioned an end wall of the pair of end walls 15b of the tray 14 at an elbow or other part of the arm of the user.

In some embodiments, the magnetic sheet 44, when coupled to the outer surface 40 of the planar portion 34 and releasably coupled to the exterior surface 12 of the tray 14 has a pull strength of at least ten pounds. In other embodiments, the magnetic sheet 44, when coupled to the outer surface 40 of the planar portion 34 and releasably coupled to the exterior surface 12 of the tray 14 have a pull strength of less than ten pounds. In other embodiments, the magnetic sheet 44, when coupled to the outer surface 40 of the planar portion 34 and releasably coupled to the exterior surface 12 of the tray 14, has a pull strength of significantly stronger than ten pounds, such as 15 pounds, 20 pounds, 25 pounds, 50 pounds, and so on.

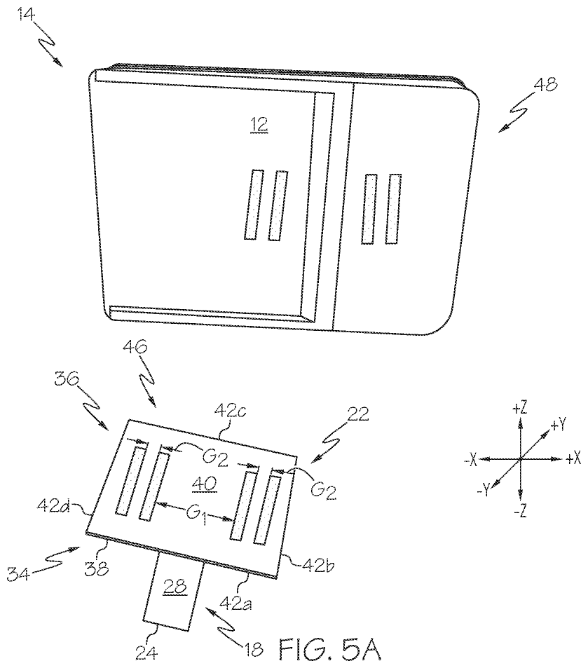

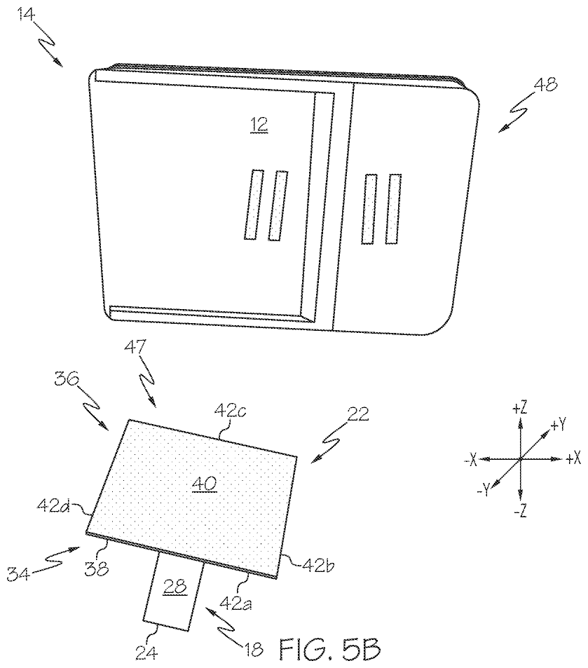

Referring now to FIGS. 5A-5B, in another embodiment, the tray attachment portion 36 may be a plurality of hook and loop fasteners 46 coupled to the outer surface 40 of the planar portion 34 and a corresponding plurality of hook and loop fasteners 48 coupled to the exterior surface 12 of the tray 14. Each of the plurality of plurality of hook and loop fasteners 46 may be spaced apart and the corresponding plurality of hook and loop fasteners 48 may also be spaced apart to match the location of the plurality of hook and loop fasteners 46 coupled to the outer surface 40 of the planar portion 34.

As such, in some embodiments, the plurality of hook and loop fasteners 46 may be coupled to the planar portion 34 to substantially cover the outer surface 40 of the planar portion 34. In other embodiments, the plurality of hook and loop fasteners 46 be 1 inch wide by 4 inchs long and may be positioned in pairs, as illustrated in FIG. 5A. As such, each of the plurality of hook and loop fasteners 46 may be spaced apart from one another creating gaps G1, G2 in an arrangement such that there is exposed portions of the outer surface 40 of the planar member 50. In some embodiments, each gap G2 between each of the plurality of hook and loop fasteners 46 that are in a group or paired is less than the space or gap G1 between pairs of the plurality of hook and loop fasteners 46.

As such, in the illustrated embodiment of FIG. 5A, the plurality of hook and loop fasteners 46 are depicted as four uniformly shaped and positioned to extend between the edges 42a, 42c with a longer portion of the hook and loop fasteners 46 extending in the same direction as edges 42b, 42d. Further, at least two of the plurality of hook and loop fasteners 46 are positioned adjacent to edges 42b, 42d of the planar portion 34. This is non-limiting, and the plurality of hook and loop fasteners 46 may be more than four or less than four. Further, each of the plurality of hook and loop fasteners 46 may be any shape and are not limited to the rectangular shape depicted. For example, each of the plurality of hook and loop fasteners 46 may be square, circular, hexagonal, octagonal, include curvilinear or arcuate portions, and/or the like. Further, each of the plurality of hook and loop fasteners 46 need not be the same shape and could be combinations to match a contour of the exterior surface 12 of the tray 14. As such, it should be appreciated that the corresponding plurality of hook and loop fasteners 48 and the mating partner of the plurality of hook and loop fasteners 46 may be identical in shape or at least overlap with one another to create the mating when in contact within one another.

As such, each of the plurality of hook and loop fasteners 46 mate with the corresponding plurality of hook and loop fasteners 48 to releasably couple the elongated member 18 to the tray 14 regardless of a material of the tray. That is, this arrangement may work on plastic trays, composite trays, metal trays, and the like. Further, such an arrangement releasably couple to the exterior surface 12 such that the elongated member 18 extends in the vertical direction (i.e., in the +/−Z direction) below the exterior surface 12 of the tray in a downward direction to allow for the user to hold onto the elongated member 18, and in some embodiments, balance the remaining portion of the exterior surface 12 on a forearm of the user or positioned at an end wall of the pair of end walls 15b of the tray 14 at an elbow or other part of the arm of the user.

In some embodiments, each of the plurality of hook and loop fasteners 46 may be coupled to the outer surface 40 of the planar portion 34 via a fastener. Example fasteners include a screw, a rivet, a bolt and nut, epoxy, adhesive, hook and loop, weld, and/or the like. In some embodiments, each of the corresponding plurality of hook and loop fasteners 48 coupled to the exterior surface 12 of the tray 14 is via a fastener. Example fasteners include a screw, a rivet, a bolt and nut, epoxy, adhesive, hook and loop, weld, and/or the like.

In some embodiments, each of the plurality of hook and loop fasteners 46 when mated or coupled to the corresponding plurality of hook and loop fasteners 48 have a pull strength of at least ten pounds. In other embodiments, each of the plurality of hook and loop fasteners 46 when mated or coupled to the corresponding plurality of hook and loop fasteners 48 have a pull strength of less than ten pounds. In other embodiments, each of the plurality of hook and loop fasteners 46 when mated or coupled to the corresponding plurality of hook and loop fasteners 48 have a pull strength of significantly stronger than ten pounds, such as 15 pounds, 20 pounds, 25 pounds, 50 pounds, and so on.

Now referring to FIG. 5B, in the illustrated embodiment, the plurality of hook and loop fasteners 46 are depicted as a hook and loop fastener sheet 47. As illustrated, the hook and loop fastener sheet 47 extends to edges 42a, 42b, 42c, 42d. This is non-limiting, and the hook and loop fastener sheet 47 may not extend to all of some of the edges 42a, 42b, 42c, 42d. As such, the shape of the hook and loop fastener sheet 47 is not limited and may be square, circular, hexagonal, octagonal, include curvilinear or arcuate portions, and/or the like. Further, the hook and loop fastener sheet 47 may not match the match the contour of the exterior surface 12 of the tray 14. As such, it should be appreciated that the corresponding plurality of hook and loop fasteners 48 and the mating partner of the hook and loop fastener sheet 47 may overlap (e.g., the hook and loop fastener sheet 47 with the corresponding plurality of hook and loop fasteners 48 or the corresponding plurality of hook and loop fasteners 48 with the hook and loop fastener sheet 47) to create the mating when in contact within one another.

As such, the hook and loop fastener sheet 47 mates with the corresponding plurality of hook and loop fasteners 48 to releasably couple the elongated member 18 to the tray 14 regardless of a material of the tray. That is, this arrangement may work on plastic trays, composite trays, metal trays, and the like. Further, such an arrangement releasably couples to the exterior surface 12 such that the elongated member 18 extends in the vertical direction (i.e., in the +/−Z direction) below the exterior surface 12 of the tray 14 in a downward direction to allow for the user to hold onto the elongated member 18, and in some embodiments, balance the remaining portion of the exterior surface 12 on a forearm of the user or positioned at an end wall of the pair of end walls 15b of the tray 14 at an elbow or other part of the arm of the user.

In some embodiments, the hook and loop fastener sheet 47 may be coupled to the outer surface 40 of the planar portion 34 via a fastener. Example fasteners include a screw, a rivet, a bolt and nut, epoxy, adhesive, hook and loop, weld, and/or the like.

In some embodiments, the hook and loop fastener sheet 47 when mated or coupled to the corresponding plurality of hook and loop fasteners 48 have a pull strength of at least ten pounds. In other embodiments, the hook and loop fastener sheet 47 when mated or coupled to the corresponding plurality of hook and loop fasteners 48 have a pull strength of less than ten pounds. In other embodiments, the hook and loop fastener sheet 47 when mated or coupled to the corresponding plurality of hook and loop fasteners 48 have a pull strength of significantly stronger than ten pounds, such as 15 pounds, 20 pounds, 25 pounds, 50 pounds, and so on.

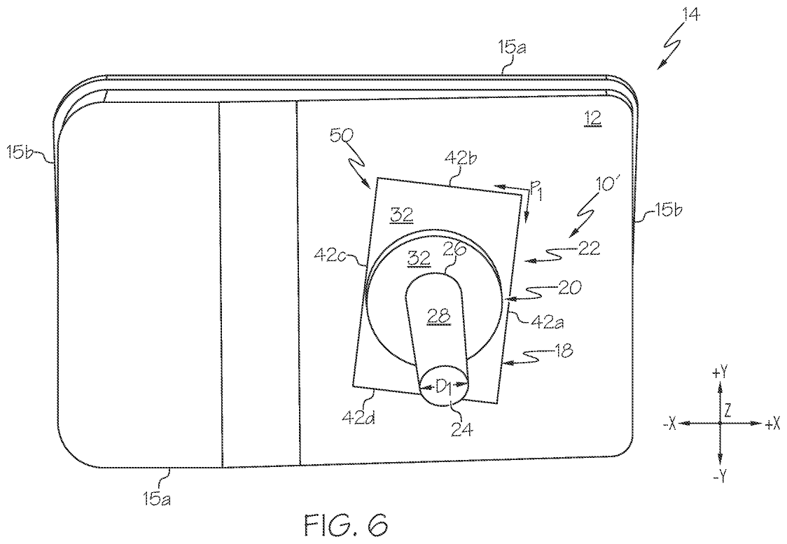

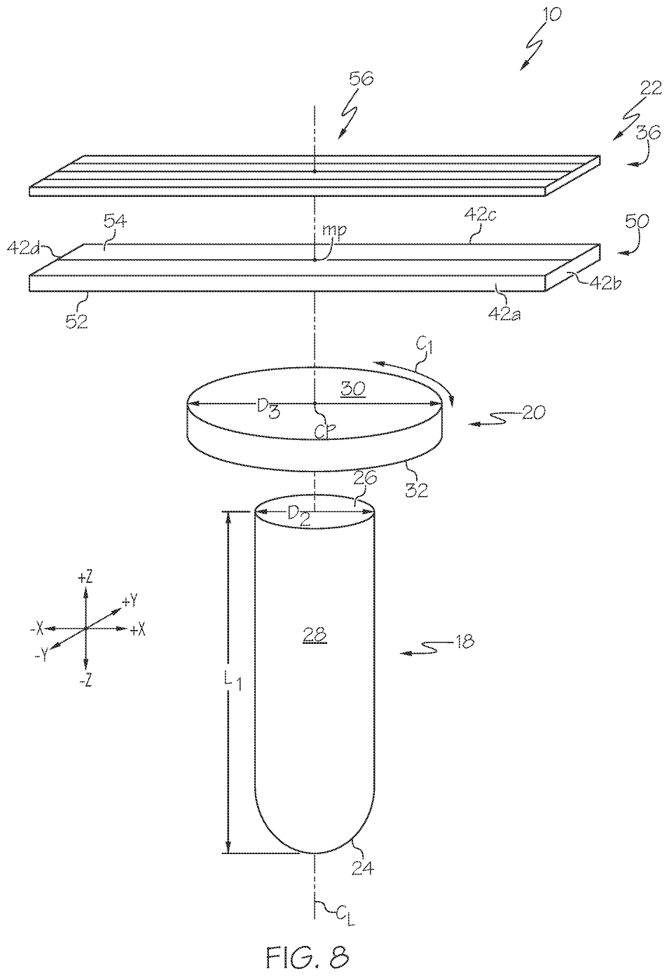

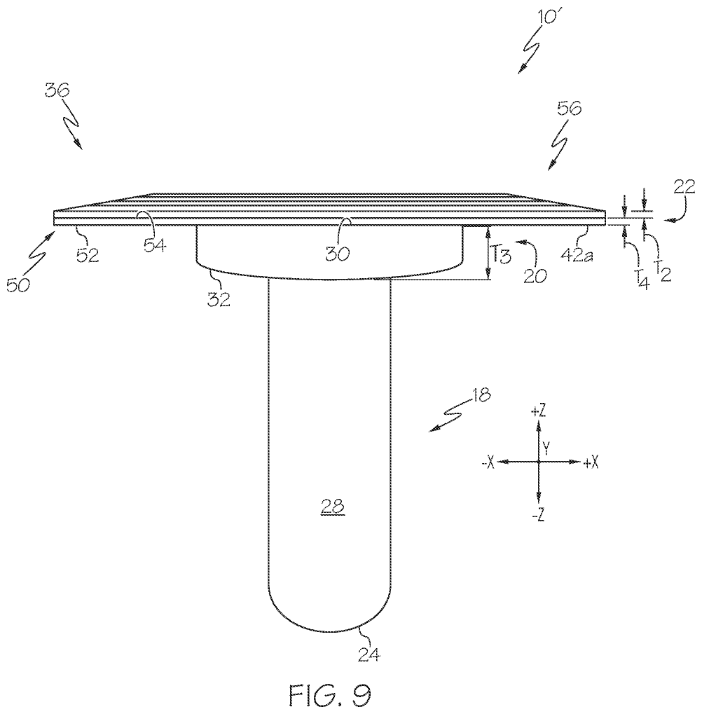

Referring now to FIGS. 6-10, a second aspect of the handle assembly 10′ is schematically depicted. It is understood that the handle assembly 10′ is similar to the handle assembly 10 with the exceptions of the features described herein. As such, like features will use the same reference numerals and, for brevity reasons, some of these features will not be described again.

The second aspect of the handle assembly 10′ includes a flange portion 20. The flange portion 20 includes an exterior surface 30 and an opposite interior surface 32. The exterior surface 30 is spaced apart from the interior surface 32 to define a thickness T3 of the flange portion 20. In a non-limiting example, the thickness T3 of the flange portion 20 is 0.5 inches. It should be understood that this is non-limiting and the thickness T3 of the flange portion 20 may be more than or less than 0.5 inches. It should be appreciated that while the flange portion is depicted as having a uniform thickness, this is for illustrative purposes and the thickness T3 of the flange portion 20 may vary. The flange portion 20 may be formed from a porous material. For example, the flange portion 20 may be formed from a sponge material, Styrofoam material, wood material, and the like.

In some embodiments, the interior surface 32 is coupled to the proximal end 26 to extend from the proximal end 26. In this embodiment, the interior surface 32 of the flange portion 20 may be coupled to the proximal end 26 via a fastener. Example fasteners include a screw, a rivet, a bolt and nut, epoxy, adhesive, hook and loop, weld, and/or the like. In other embodiments, the flange portion 20 is a monolithic structure with the elongated member 18 and the flange portion 20 extends from the proximal end 26 as a single piece. As such, the elongated member 18 and the flange portion 20 may be formed together during manufacturing. The flange portion 20 is generally circular in shape and is coaxially aligned with the centerline C1 of the elongated member 18. As such, a center point CP of the flange portion 20 is coaxially aligned with the center line CL of the elongated member 18.

The flange portion 20 extends radially outward from the center point CP to extend perpendicular away or beyond from the proximal end 26. As such, the flange portion 20 has a diameter D3. In a non-limiting example, the third diameter D3 of the flange portion 20 is 3 inches. It should be understood that this is non-limiting and the diameter D3 of the flange portion 20 may be more than or less than 3 inches. In some embodiments, the diameter D3 is greater than the diameter D2 to provide an absorbing boundary and/or padding between the elongated member 18 and the planar portion 34. That is, the diameter D3 of the flange portion 20 is larger than the than the diameter D2 of the proximal end 26 such that portions of the planar portion 34 is separated from a hand of the user gripping the elongated member 18. This is non-limiting and the diameter D3 of the flange portion 20 may be less than the diameter D2 of the proximal end 26.

Further, the flange portion 20 includes an outer circumference C1. The outer circumference C1, while illustrated as uniform, may change, or be irregular. For example, should the dimensions of the exterior surface 30 be different or vary from the dimensions of the interior surface 32, the outer circumference may be tapered or shaped in a non-uniform manner. As illustrated, in some embodiments, the outer circumference C1 of the flange portion 20 is greater than the proximal end 26. Further, in other embodiments, the outer circumference C1 of the flange portion 20 is greater than the distal end 24. In other embodiments, the outer circumference C1 of the flange portion 20 is equal to or less than the distal end 24. Further, the flange portion 20 is not limited to the circular shape, as depicted, and may be any shape including square, rectangular, hexagonal, octagonal, and the like.

In the second aspect of the of the handle assembly 10′, the quick-release attachment assembly 22 is coupled to the exterior surface 30 of the flange portion 20. The quick-release attachment assembly 22 includes a planar member 50 and the tray attachment portion 36. The planar member 50 has an inner surface 52 and an opposite and an outer surface 54 that is spaced apart from the inner surface 52 to define a thickness T4 of the planar member 50. In a non-limiting example, the thickness T4 of the planar member 50 is ⅛ inch. It should be understood that this is non-limiting and the thickness T4 of the planar member 50 may be more than or less than ⅛ inch. It should be understood that the thickness T4 provides for a stable attachment or coupling surface for the tray attachment portion 36, as discussed in greater detail herein. It should also be appreciated that while the planar member 50 is depicted as having a uniform thickness, this is for illustrative purposes and the thickness T4 of the planar member 50 may vary.

Referring still to FIGS. 6-10, in the illustrated embodiment, portions of the inner surface 52 may be coupled to the exterior surface 30 of the flange portion 20 and to the proximal end 26 of the elongated member 18. In this embodiment, portions of the inner surface 38 of the planar member 50 may be coupled to the exterior surface 30 of the flange portion 20 via a fastener. Example fasteners include a screw, a rivet, a bolt and nut, epoxy, adhesive, hook and loop, weld, and/or the like. In this embodiment, portions of the inner surface 38 of the planar member 50 may also be coupled to the proximal end 26 of the elongated member 18 via a fastener. Example fasteners include a screw, a rivet, a bolt and nut, epoxy, adhesive, hook and loop, weld, and/or the like.

In some embodiments, the planar member 50 may generally be a rectangular shape with the four edges 42a, 42b, 42c, 42d positioned radially outward from the mid-point MP centrally positioned between the four edges 42a, 42b, 42c, 42d. The mid-point MP may be coaxially aligned with the central line CL of the elongated member 18 such that the planar member 50 is coaxially aligned with the flange portion 20, which in turn is coaxially aligned with the elongated member 18.

It should be understood that the generally rectangular shape is non-limiting and the planar member 50 may be any other shape including circular, square, hexagonal, octagonal, and the like. Each of the four edges 42a, 42b, 42c, 42d form the perimeter P1 that is positioned or terminates beyond the outer circumference C1 of the flange portion 20. As such, the perimeter P1 of the planar member 50 extends beyond the outer circumference C1 of the flange portion 20 and may have a greater area than the flange portion 20. In some embodiments, the perimeter P1 is 17 inches as discussed in the examples provided above. It should be understood that this is non-limiting and each length of the sides may vary thus changing the perimeter P1 of the planar member 50 to be more than or less than 17 inches. As such, the planar member 50 has a greater surface area than the flange portion 20.

In some embodiments, the surface area of the planar member 50 may be greater than that of the outer circumference C1 of the flange portion 20 to provide a stable platform for the tray attachment portion 36 to couple to the outer surface 40 of the planar member 50. That is, in a non-limiting example, the surface area of the planar member 50 is 150 percent larger than that of the flange portion 20. This is non-limiting and the surface area of the planar member 50 may be less than 1.5 times larger than the flange portion 20 or the surface area of the planar member 50 may be greater than 1.5 times larger than the flange portion 20.

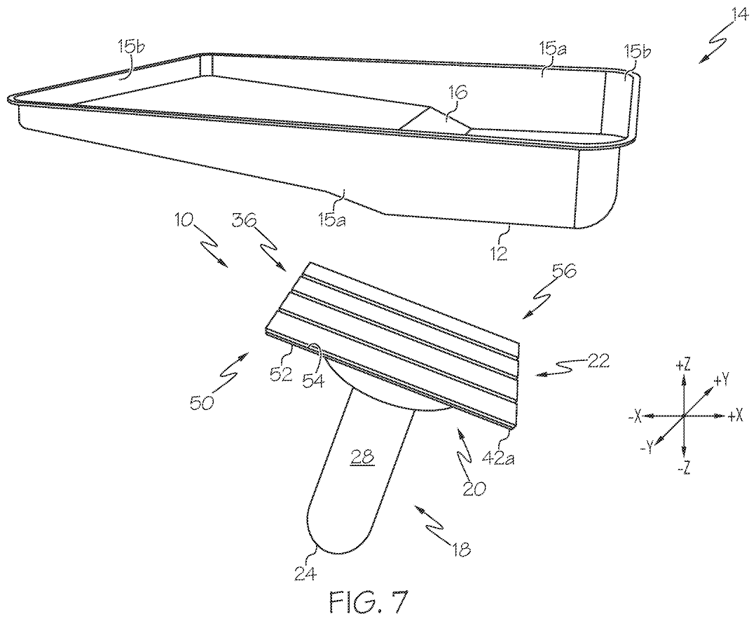

Referring now to FIGS. 7-9, the tray attachment portion 36 is coupled to the outer surface 40 of the planar member 50. In one embodiment, the tray attachment portion 36 may be a single magnetic strip and/or a plurality of magnetic strips 56 coupled to the outer surface 40 of the planar member 50. Each of the plurality of magnetic strips 56 44 may be coupled to substantially cover the outer surface 40 of the planar member 50. In some embodiments, each of the plurality of magnetic strips 56 may be coupled to the outer surface 40 of the planar member 50 via a fastener. Example fasteners include a screw, a rivet, a bolt and nut, epoxy, adhesive, hook and loop, weld, and/or the like.

Each of the plurality of magnetic strips 56 coupled to the outer surface 40 of the planar member 50 may have a length greater than a width so to be arranged in the longitudinal direction (i.e., in the +/−X direction) and positioned along an edge-to-edge arrangement in the lateral direction (i.e., in the +/−Y direction). That is, in some embodiments, each of the plurality of magnetic strips 56 have a length in the longitudinal direction (i.e., in the +/−X direction) that is greater than a width in a lateral direction (i.e., in the +/−Y direction). As such, in a non-limiting example, the depicted embodiment, the plurality of magnetic strips 56 are illustrated as four magnetic strips. This is non-limiting and there may be more than four magnetic strips or less than four magnetic strips. For example, there may be a single sheet in place of the plurality of magnetic strips 56.

Each of the plurality of magnetic strips 56 are configured to releasable couple the elongated member 18 to the exterior surface 12 of the tray 14 in case where the tray 14 is made of, or from, or has, a magnetic material. For example, the tray 14 may be made from a metal material that is magnetic. As such, the plurality of magnetic strips 56 releasably couple to the exterior surface 12 such that the elongated member 18 extends in the vertical direction (i.e., in the +/−Z direction) below the exterior surface 12 of the tray in a downward direction. Such an arrangement allows for the user to hold onto the elongated member 18, and in some embodiments, balance the remaining portion of the exterior surface 12 on a forearm of the user or positioned an end wall of the pair of end walls 15b of the tray 14 at an elbow or other part of the arm of the user.

In some embodiments, each of the plurality of magnetic strips 56 when coupled to the outer surface 40 of the planar member 50 and releasably coupled to the exterior surface 12 of the tray 14 have a pull strength of at least ten pounds. In other embodiments, each of the plurality of magnetic strips 56 when coupled to the outer surface 40 of the planar member 50 and releasably coupled to the exterior surface 12 of the tray 14 have a pull strength of less than ten pounds. In other embodiments, each of the plurality of magnetic strips 56 when coupled to the outer surface 40 of the planar member 50 and releasably coupled to the exterior surface 12 of the tray 14 have a pull strength of significantly stronger than ten pounds, such as 15 pounds, 20 pounds, 25 pounds, 50 pounds, and so on.

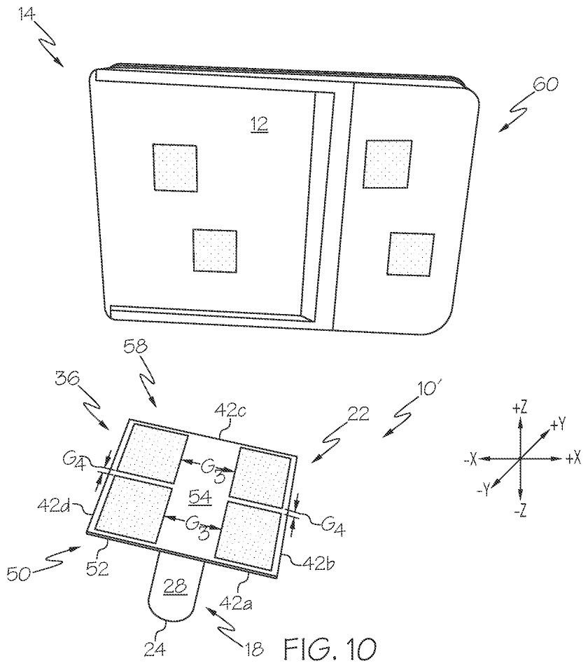

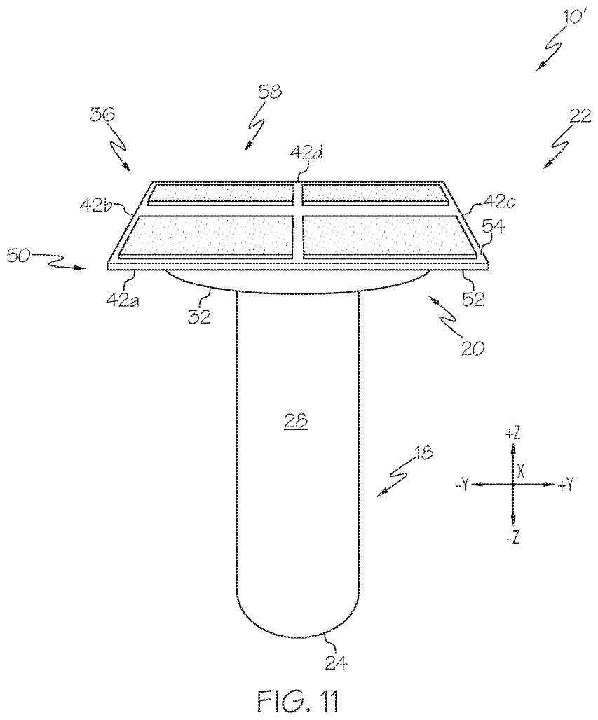

Referring now to FIGS. 10-11, in another embodiment, the tray attachment portion 36 may be a plurality of hook and loop fasteners 58 coupled to the outer surface 40 of the planar member 50 and a corresponding plurality of hook and loop fasteners 60 coupled to the exterior surface 12 of the tray 14. Each of the plurality of plurality of hook and loop fasteners 58 may be spaced apart and the corresponding plurality of hook and loop fasteners 60 may also be spaced apart to match the location of the plurality of hook and loop fasteners 58 coupled to the outer surface 40 of the planar member 50.

As such, in some embodiments, the plurality of hook and loop fasteners 58 may be coupled to the planar member 50 to substantially cover the outer surface 40 of the planar member 50. In other embodiments, the plurality of hook and loop fasteners 58 may be spaced apart creating gaps G3, G4 in an arrangement that there is exposed portions of the outer surface 40 of the planar member 50. In some embodiments, each gap G3 between each of the plurality of hook and loop fasteners 58 is larger in the longitudinal direction (i.e., in the +/−X direction) than the gap G4 between each of the plurality of hook and loop fasteners 58 in a lateral direction (i.e., in the +/−Y direction).

As such, in the illustrated embodiments, the plurality of hook and loop fasteners 58 are depicted as four uniformly shaped and positioned in the four corners of the planar member 50. This is non-limiting, and the plurality of hook and loop fasteners 58 may be more than four or less than four, such as a single sheet. Further, each of the plurality of hook and loop fasteners 58 may be any shape and are not limited to the square shape depicted. For example, each of the plurality of hook and loop fasteners 58 may be rectangular, circular, hexagonal, octagonal, include curvilinear or arcuate portions, and/or the like. Further, each of the plurality of hook and loop fasteners 58 need not be the same shape and could be combinations to match a contour of the exterior surface 12 of the tray 14. As such, it should be appreciated that the corresponding plurality of hook and loop fasteners 60 and the mating partner of the plurality of hook and loop fasteners 58 may be identical in shape or at least overlap with one another to create the mating when in contact within one another.

As such, each of the plurality of hook and loop fasteners 58 mate with the corresponding plurality of hook and loop fasteners 60 to releasably couple the elongated member 18 to the tray 14 regardless of a material of the tray. That is, this arrangement may work on plastic trays, composite trays, metal trays, and the like. Further, such an arrangement releasably couple to the exterior surface 12 such that the elongated member 18 extends in the vertical direction (i.e., in the +/−Z direction) below the exterior surface 12 of the tray in a downward direction to allow for the user to hold onto the elongated member 18, and in some embodiments, balance the remaining portion of the exterior surface 12 on a forearm of the user or positioned at an end wall of the pair of end walls 15b of the tray 14 at an elbow or other part of the arm of the user.

In some embodiments, each of the plurality of hook and loop fasteners 58 may be coupled to the outer surface 40 of the planar member 50 via a fastener. Example fasteners include a screw, a rivet, a bolt and nut, epoxy, adhesive, hook and loop, weld, and/or the like. In some embodiments, each of the corresponding plurality of hook and loop fasteners 60 coupled to the exterior surface 12 of the tray 14 is via a fastener. Example fasteners include a screw, a rivet, a bolt and nut, epoxy, adhesive, hook and loop, weld, and/or the like.

In some embodiments, each of the plurality of hook and loop fasteners 58 when mated or coupled to the corresponding plurality of hook and loop fasteners 60 have a pull strength of at least ten pounds. In other embodiments, each of the plurality of hook and loop fasteners 58 when mated or coupled to the corresponding plurality of hook and loop fasteners 60 have a pull strength of less than ten pounds. In other embodiments, each of the plurality of hook and loop fasteners 58 when mated or coupled to the corresponding plurality of hook and loop fasteners 60 have a pull strength of significantly stronger than ten pounds, such as 15 pounds, 20 pounds, 25 pounds, 50 pounds, and so on.

It should now be understood that the embodiments described herein are directed to a handle assembly for releasable coupling to an exterior surface of a fluid container, such as a tray that is configured to retain a fluid, such as paint. The handle assembly includes an elongated member that has a distal end an opposite proximal end and a planar portion. The planar portion is configured to receive various tray connectors of a quick-release attachment assembly to releasable couple the elongated member to the exterior surface of the tray. Example tray connectors of the quick-release attachment assembly include magnets, hook and loop fasteners, and the like, positioned on or coupled to the outer surface of the planar portion.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A handle assembly for releasable coupling to an exterior surface of a tray that is configured to retain a fluid, the handle assembly comprising:
a base member having:
an elongated member having a distal end, an opposite proximal end and a planar portion having an outer surface, the planar portion positioned to extend from the proximal end and above the proximal end of the elongated member in a vertical direction; and
a quick-release attachment assembly having:
an interior surface and an opposite exterior surface, the interior surface coupled to and extending from the outer surface of the planar portion of the elongated member, the exterior surface of the quick-release attachment assembly adapted to releasable couple the elongated member to the exterior surface of the tray.

2. The handle assembly of claim 1, wherein:
the quick-release attachment assembly is a magnetic sheet is coupled to the outer surface of the planar portion,
wherein the magnetic sheet is configured to releasable couple the elongated member to the exterior surface of the tray when the exterior surface is magnetic.

3. The handle assembly of claim 2, wherein the magnetic sheet coupled to the outer surface of the planar portion has a pull strength of at least ten pounds.

4. The handle assembly of claim 1, wherein:
the quick-release attachment assembly is a plurality of magnetic strips coupled to the outer surface of the planar portion,
wherein the plurality of magnetic strips are configured to releasable couple the elongated member to the exterior surface of the tray when the exterior surface is magnetic.

5. The handle assembly of claim 4, wherein the plurality of magnetic strips coupled to the outer surface of the planar portion are arranged in a longitudinal direction and positioned along an edge-to-edge arrangement.

6. The handle assembly of claim 5, wherein each of the plurality of magnetic strips have a length in the longitudinal direction that is greater than a width in a lateral direction.

7. The handle assembly of claim 6, wherein the plurality of magnetic strips coupled to the outer surface of the planar portion are four magnetic strips.

8. The handle assembly of claim 4, wherein each of the plurality of magnetic strips coupled to the outer surface of the planar portion have a pull strength of at least ten pounds.

9. The handle assembly of claim 1, wherein:
the quick-release attachment assembly is a hook and loop fastener coupled to the outer surface of the planar portion, and
a corresponding receiving hook and loop fastener positioned on the exterior surface of the tray,
wherein the hook and loop fastener is configured to releasable couple the elongated member to the exterior surface of the tray when mated with the corresponding receiving hook and loop fastener positioned on the exterior surface of the tray.

10. The handle assembly of claim 1, wherein:
the quick-release attachment assembly is a plurality of hook and loop fasteners coupled to the outer surface of the planar portion, and
a plurality of corresponding receiving hook and loop fasteners positioned on the exterior surface of the tray,
wherein the plurality of hook and loop fasteners are configured to releasable couple the elongated member to the exterior surface of the tray when mated with the plurality of corresponding receiving hook and loop fasteners positioned on the exterior surface of the tray.

11. The handle assembly of claim 10, wherein:
each of the plurality of hook and loop fasteners are spaced apart, and
each of the plurality of corresponding receiving hook and loop fasteners positioned on the exterior surface of the tray are spaced apart.

12. The handle assembly of claim 11, wherein a gap between each of the plurality of hook and loop fasteners is larger in a lateral direction than a gap between each of the plurality of hook and loop fasteners in a longitudinal direction.

13. The handle assembly of claim 1, wherein a mid-point of the planar portion is coaxially aligned with a center axis of the elongated member.

14. A handle assembly for releasable coupling to an exterior surface of a paint tray, the handle assembly comprising:
an elongated member having a distal end, an opposite a proximal end, and a planar portion having an outer surface, the planar portion positioned to extend from the proximal end and above the proximal end of the elongated member in a vertical direction;
a magnetic sheet coupled to the outer surface of the planar portion and adapted to releasable couple the elongated member to the exterior surface of the paint tray when the exterior surface is magnetic.

15. The handle assembly of claim 14, wherein the magnetic sheet is a plurality of magnetic strips coupled to the outer surface of the planar portion, the plurality of magnetic strips are configured to releasable couple the elongated member to the exterior surface of the paint tray when the exterior surface is magnetic.

16. The handle assembly of claim 15, wherein the plurality of magnetic strips coupled to the outer surface of the planar portion are arranged in a longitudinal direction and positioned along an edge-to-edge arrangement.

17. The handle assembly of claim 14, wherein the magnetic sheet coupled to the outer surface of the planar portion has a pull strength of at least ten pounds.

18. A handle assembly for releasable coupling to an exterior surface of a paint tray, the exterior surface of the paint tray having a plurality of corresponding receiving hook and loop fasteners positioned thereon, the handle assembly comprising:
an elongated member having a distal end, an opposite proximal end, and a planar portion having an outer surface, the planar portion positioned to extend from the proximal end and above the proximal end of the elongated member in a vertical direction; and
a plurality of hook and loop fasteners coupled to the outer surface of the planar portion,
wherein the plurality of hook and loop fasteners are configured to releasable couple the elongated member to the exterior surface of the paint tray when mated with the plurality of corresponding receiving hook and loop fasteners positioned on the exterior surface of the paint tray.

19. The handle assembly of claim 18, wherein:
each of the plurality of hook and loop fasteners are spaced apart, and
each of the plurality of corresponding receiving hook and loop fasteners positioned on the exterior surface of the paint tray are spaced apart.

20. The handle assembly of claim 18, wherein a gap between each of the plurality of hook and loop fasteners is larger in a lateral direction than a gap between each of the plurality of hook and loop fasteners in a longitudinal direction.
